(19) United States
(12) Patent Application Publication
(10) Pub. No.: US 2008/0313723 A1
(43) Pub. Date: Dec. 18, 2008

(54) AUTHENTICATION METHOD OF INFORMATION TERMINAL

(76) Inventors: Norihiko NAONO, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/138,120

(22) Filed: Jun. 12, 2008

(30) Foreign Application Priority Data
Jun. 15, 2007 (JP) P2007-159326

(51) Int. Cl. H04L 9/32

(52) U.S. Cl. 726/7

(57) ABSTRACT

One embodiment of the present invention provides an information terminal that includes: a first receiver for receiving trust information from a trust information provider, the trust information including identification information of a terminal belonging to an authenticatee and showing that the terminal belonging to the authenticatee is authenticated by the trust information provider; a storage device for storing the trust information; a second receiver for receiving an identification tag of the terminal belonging to the authenticatee from a server; and an outputting device for outputting information for performing an identification judgment of the terminal belonging to the authenticatee based on the identification tag of the terminal belonging to the authenticatee and the trust information stored in the storage device.

### CROSS REFERENCE TO RELATED APPLICATION

This application is based upon and claims the benefit of priority from the prior Japanese Patent Application No. 2007-159326, filed on Jun. 15, 2007; the entire contents of which are incorporated herein by reference.

### BACKGROUND OF THE INVENTION

1. Field of the Invention

The present invention is related to an authentication method of an information terminal.

2. Description of the Related Art

Confidentiality, authentication, integrity and non-repudiation are essential for the safety of information which is exchanged over a network such as the internet. Among these factors, authentication means to assure that the person you are communicating with over a network is the person himself or herself and not any other person. Generally, authentication is performed using an asymmetric encryption method where a pair of keys such as a public key and a private key are used and not by using a symmetric encryption method. The method of authentication, where a pair of keys such as a public key and private key are used, is broadly classified into a centralized and a distributed encryption system. In the centralized encryption system, as known as X.509 and as disclosed by U.S. Pat. No. 4,405,829, the trust of certificate authority, which is the root certificate authority, is linked to the user by using the pair of keys. In the distributed encryption system, similar to the case of PGP (Pretty Good Privacy), which is disclosed for example by RFC1991, mutual authentication between the users is performed and propagated over an entire network without the intervention of the certificate authority.

These authentications are broadly classified into two levels, namely; low-level authentication and high-level authentication. In this section, the difference in the trust levels is described by using the centralized encryption system, which is widely used. In the low-level authentication, the certificate authority does not issue a digital certificate after confirming that the authenticatee is the person himself or herself. This system only assures that the public key of the authenticatee obtained by the authenticator forms a pair with the private key possessed by the authenticatee. For example, even if a malicious third person pretends to be the authenticatee to obtain the digital certificate of the public key for the e-mail address of the authenticatee from the certificate authority, the certificate authority does not certify this person whether they are the actual authenticatee or a malicious third person. On the other hand, in the high-level authentication, when it is assured that the public key of the authenticatee obtained by the authenticator forms a pair with the private key possessed by the authenticatee, it is certified at the same time that the public key belongs to the actual authenticatee. Besides the certification technique where a pair of keys such as a public key and private key is used, the certificate authority requires a mechanism for high-level authentication, where the authenticatee is identified through their reporting to a certificate authority operator, or the personal information of the authenticatee, who is already registered by the certificate authority operator, is verified. This identification process is expensive. Therefore, mostly the low-level authentication is provided where certificate authority uses a pair of keys such as a public key and private key for authentication, without executing an identification process.

Authentication through PGP, which is a typical distributed encryption system, is a technology wherein it is possible to form a chain of trust over a network in the absence of root certificate authority, by putting a signature of one or more direct or indirect acquaintances to the digital certificate which has the signature of the actual authenticatee. For example, in PGP, multiple users, who trust User A, can sign the digital certificate of User A. The public key of these signatories is necessary when verifying the digital certificate of User A, who is the authenticatee having the signatures of multiple users; and the public keys of these signatories are also signed in the same way by the user, who trusts these signatories. In PGP, a state is created where the user in a network is authenticated by multiple users. Therefore, it is possible to maintain a chain of trust over an entire network even in the absence of certificate authority.

The problem in the centralized authentication technology in which the chains of trust of root certificate authorities are linked is that only a few network browsers such as certificate authority operators are granted special authority, which is the origin of the chains of trust in the entire network. This is the reason why a distributed authentication system such as PGP was proposed. In addition, this authentication technology is expensive since the certificate authority requires considerable manpower in order to execute a high-level authentication as mentioned previously.

In the distributed authentication technology such as PGP, the origin of trust is distributed to all network users and not only to the certificate authority which has special rights. Moreover, when it is necessary to increase the level of authentication, if the digital certificate of the authenticatee is signed after the direct acquaintances execute a high-level authentication through telephone, e-mail, mail etc., then the high cost incurred by the certificate authority operator in centralized authentication technology is distributed over the entire network. This is an important benefit. In recent years, this type of distributed encryption system is becoming increasingly popular.

However, there are three problems in the distributed authentication technology mentioned above. The first problem is that it cannot be assured whether the determined authentication level is obtained or not. In a centralized system, it is possible to enforce a particular action for the authenticatee to implement the desired level of authentication. Thus, higher level authentication can be assured with some additional cost. However, in distributed authentication technology, there is no specific authority in the network who is responsible for the authentication; therefore, no action can be enforced on the network users. In PGP, when signing the digital certificate, the authenticatee and authenticator check the numeric value or password through telephone etc. and thus execute a high-level identification process. This is the method for the authenticator to sign by using their private key. If almost all users in the network execute this type of identification process, it is technically possible to establish a high-level authentication. However, actually, a specific level of authentication cannot be assured without enforcing all the users to take an action that cannot be automated by the terminal.

The second problem is, when the malicious third person manages to obtain the private key with the public key of the authenticatee, who has received many signatures, from their terminal, the authenticator can rarely detect it. In PGP, for example, Users B and C have signed the digital certificate of User A who is the authenticatee. Even if a malicious third person manages to obtain the private key with the digitally attested public key of User A, the fact remains that Users B and C have signed the digital certificate of this public key. Therefore, unless the public key and private key of this User A is nullified, the malicious third person can completely pretend to be User A. The nullification of these keys is difficult compared to the centralized encryption system mentioned above, since there is no certificate authority possessing this right.

The third problem is that the authenticator cannot authenticate the authenticatee until they receive a message from the authenticatee. Authenticatee A has to send a message or its hash value and a certificate signed with the private key of the authenticator to authenticator B in either the centralized system or distributed encryption system, and then authenticator B has to authenticate the message or its hash value by verification with the public key of authenticatee A. Personal information such as an e-mail address, which is necessary to contact the authenticatee A, is revealed to Authenticator B when receiving the signed certificate from authenticatee A. However, authenticatee A may not wish to reveal such information to authenticator B. The type of information authenticatee A sends to authenticator B is not related to the authentication whereby authenticator B authenticates the actual authenticatee A. However, authenticatee A cannot obtain the authentication from authenticator B until authenticatee A reveals a communication method to User B.

### BRIEF SUMMARY OF THE INVENTION

While considering all of the above circumstances, an economical method for implementing a higher level of authentication than the personal information of a trust information provider compared to conventional technology is provided as an embodiment of the present invention.

One embodiment of the present invention provides an information terminal comprising: a first receiver, the first receiver receiving trust information from a trust information provider, the trust information including identification information of a terminal belonging to an authenticatee, the trust information showing that the terminal belonging to the authenticatee is authenticated by the trust information provider; a storage device, the storage device storing the trust information; a second receiver, the second receiver receiving an identification tag of the terminal belonging to the authenticatee from a server; and an outputting device, the outputting device outputting information for performing an identification judgment of the terminal belonging to the authenticatee based on the identification tag of the terminal belonging to the authenticatee and the trust information stored in the storage device.

One embodiment of the present invention provides an information terminal comprising: a first receiver, the first receiver receiving identification information of a terminal belonging to an authenticatee; a storage device, the storage device storing the identification information of the terminal belonging to the authenticatee; a second receiver, the second receiver receiving trust information which includes an identification tag of the terminal belonging to the authenticatee, the trust information showing that the terminal belonging to the authenticatee is authenticated by a trust information provider; and an outputting device, the outputting device outputting information for performing an identification judgment of the terminal based on the trust information and the identification information stored in the storage device.

One embodiment of the present invention provides an information providing method comprising: receiving trust information, the trust information including a hash value of an identification tag of a terminal belonging to an authenticatee, and including an identification tag of a terminal belonging to a trust information provider; storing the trust information as a trust information database record in a storage device; receiving the identification tag of the terminal belonging to the authenticatee from a server; generating a specific hash value by a calculation part, the specific hash value being generated based on the identification tag of the terminal belonging to the authenticatee; searching a record from the storage device by a search operation part, the record including the specific hash value; and performing an identification judgment of the terminal belonging to the authenticatee based on the identification tag of the terminal belonging to the trust information provider, the identification tag being included in the searched record.

One embodiment of the present invention provides an information providing method comprising; receiving trust information which includes a calculation result of an identification tag of a terminal belonging to an authenticatee and an identification tag of a terminal belonging to a trust information provider or a hash value of the calculation result; storing the trust information as a trust information database record in a storage device; receiving the identification tag of the terminal belonging to the authenticatee from a server; generating a specific calculation result by a calculation part based on the identification tag of the terminal belonging to the authenticatee and the identification tag of the terminal belonging to the trust information provider; searching a record from the storage device by a search operation part, the record including the calculation result; and performing an identification judgment of the terminal belonging to the authenticatee based on the identification tag of the terminal belonging to the trust information provider, the identification tag being included in the searched record.

One embodiment of the present invention provides an information providing method comprising; receiving trust information which includes a calculation result, the calculation result being an encryption of additional information which is added when a terminal belonging to an authenticatee is authenticated by a trust information provider, and an identification tag of the terminal belonging to the authenticatee being used as an encryption key; storing the trust information as a trust information database record in a storage device; receiving a specific identification tag of the terminal belonging to the authenticatee from a server; decrypting the record of the trust information database by a calculation part, the specific identification tag of the terminal belonging to the authenticatee being used as a decryption key; and performing an identification judgment of the terminal belonging to the authenticatee based on the additional information.

### BRIEF DESCRIPTION OF THE DRAWINGS

FIG. 1 shows a situation in which trust information provides C and D transmit trust information when authenticator B authenticates authenticatee A.

FIG. 2 shows a block diagram of a terminal belonging to User C, who is a trust information provider.

FIG. 3 shows a block diagram of a terminal belonging to User D, who is a trust information provider.

FIG. 4 shows a block diagram of a terminal belonging to User B, who is an authenticator.

FIG. 5 is a flowchart for explaining each step of an embodiment of the present invention.

FIG. 6 is a drawing of examples of trust information of the first, the second, and the third types of the embodiment 1 of the present invention.

FIG. 7 is a flowchart of the processing in the terminal belonging to the authenticator on the reception of trust information of the first type.

FIG. 8 is a flowchart of the processing in the terminal belonging to the authenticator on the reception of trust information of the second type.

FIG. 9 is a flowchart of the processing in the terminal belonging to the authenticator on the reception of trust information of the third type.

FIG. 10 is a flowchart of the processing on the reception of trust information of the first, the second, and the third type.

FIG. 11 is a drawing of examples of trust information of the first, the second, and the third types of the embodiment 2 of the present invention.

FIG. 12 is a drawing of examples of trust information of the first, the second, and the third types of the embodiment 2 of the present invention.

### DETAILED DESCRIPTION OF THE INVENTION

The best possible embodiments to implement the present invention are described below. Since the scope of present invention is defined clearly according to the appended claims, this description is given in order to exemplify the topic of this invention, and should not be interpreted to be restricted to the embodiments below.

The present invention is directed to methods, systems and equipment for providing information electronically over a network. The invention can be applied to authentication between various terminals which are connected to a network. The information terminals or communication terminals that can be used are personal computers, personal digital assistants, fixed-line telephones, cellular phones, television sets, video recorders, cameras, video cameras, or portable music players and so on. Moreover, the types of the information terminal of an authenticatee, the terminal of a trust information provider, and the terminal of an authenticatee may be different. For example, by using the methods of an embodiment of the present invention, the user of a game machine can also authenticate a cellular phone on the basis of trust information obtained from the user of a personal computer.

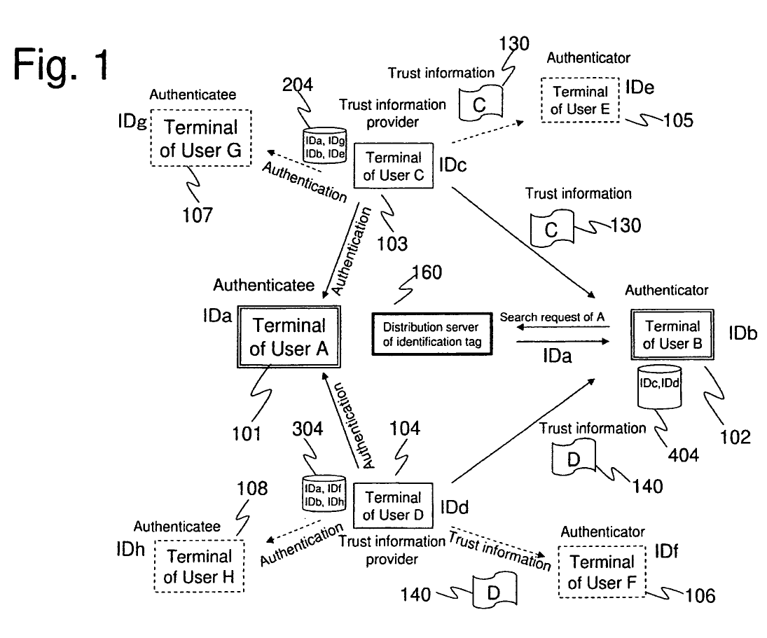

In FIG. 1, terminal 101 of User A, terminal 102 of User B, terminal 103 of User C, terminal 104 of User D, terminal 105 of User E, terminal 106 of User F, terminal 107 of User G, terminal 108 of User H, and identification tag distribution server 160 are connected via a network. The respective terminals of User A, B, C, D, E, F, G and H have identification tags such as IDa, IDb, IDc, IDd, IDe, IDf, IDg and IDh to specify each User uniquely on the network. In this invention, the terminal 102 of User B receives trust information 130 and 140 respectively from the terminal 103 of User C and from the terminal 104 of User D, and displays the information that Users C and D have authenticated the terminal 101 as User A's terminal. On the basis of this information, User B can execute easy and high-level authentication indicating that the terminal 101 communicated through the terminal 102, belongs to User A. As shown in FIG. 1, User A is the authenticatee and User B is the authenticator.

Here, authentication means to confirm that the terminal with whom the authenticator is communicating through the network is being used by the actual authenticatee with whom the authenticator intends to communicate. This is expressed below by the phrase “Authenticating that terminal 101 belongs to User A” or simply “Authenticating User A” for example. Thus, the present invention provides methods to the authenticator for easy high-level authentication wherein it is verified that the user of a terminal is the actual person, and it does not provide low-level authentication, in which identity verification is not executed. In FIG. 1, the terminals of Users and authentications which are not directly related to the description of the methods of the present invention in which User B, through terminal 102, authenticates that terminal 101 belongs to User A are shown with a dotted line.

As shown in FIG. 1, User C who is a trust information provider, authenticates that terminal 107 is of User G, and User D who is a trust information provider, authenticates that terminal 108 is of User H. Both User C and User D also authenticate that terminal 101 belongs to User A. Moreover, User C who is a trust information provider, provides trust information 130 to User E and User B. User D who is a trust information provider, provides trust information 140 to User F and User B.

As shown in FIG. 1, identification tags IDa, IDb, IDe, and IDg of Users A, B, E, and G respectively are stored in the storage device 204 in the terminal of User C. In addition, User C authenticates Users A, B, E, and G. Furthermore, as shown in FIG. 1, identification tags IDa, IDb, IDf, and IDh of User A, B, F, and H respectively are stored in the storage device 304 in the terminal of User D and User D authenticates User A, B, F, and H. Similarly, identification tag IDc of terminal 103 of User C and identification tag IDd of terminal 104 of User D are stored in the storage method 404 in the terminal of User B. As stated above, User B authenticates User C and User D.

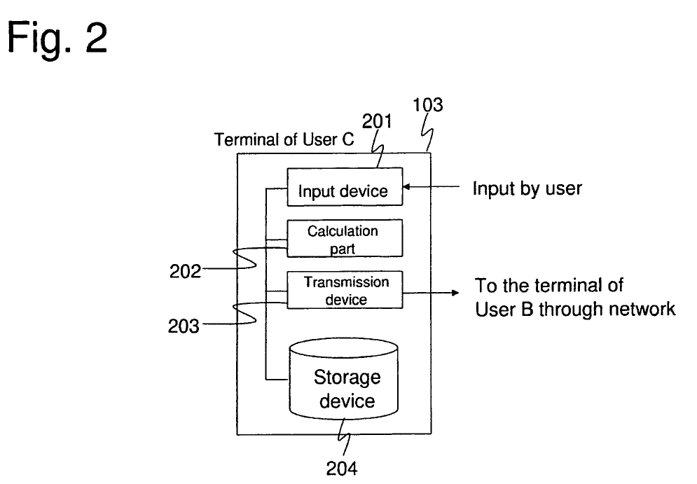

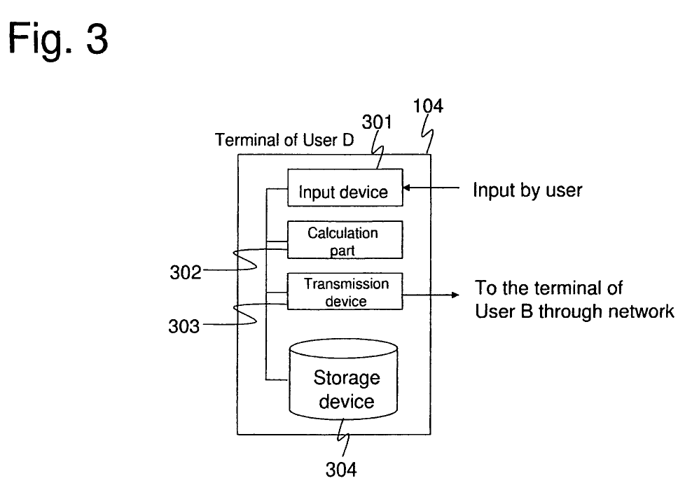

FIG. 2 shows an example of components required by the terminal 103 of User C, who provides the trust information to implement an embodiment of the present invention. The terminal 103 of User C, who is a trust information provider, comprises an input device 201, a calculation device 202, a transmission/reception device 203, and a storage device 204. Similarly, FIG. 3 shows the components required by terminal 104 of User D, who also provides the trust information to implement the present invention. The terminal 104 of User D, who is another trust information provider, comprises an input device 201, a calculation device 202, a transmission/reception device 203, and a storage device 204.

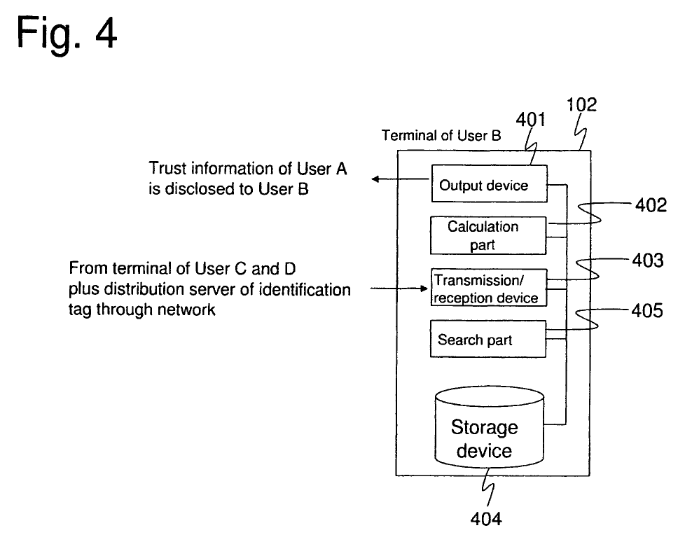

FIG. 4 shows the components required by the terminal of User B, who is the authenticator to implement an embodiment of the present invention. User B's terminal, in other words, authenticator's terminal 102 comprises an output device 401, a calculation device 402, a transmission/reception device 403, a storage device 404 and a search part 405.

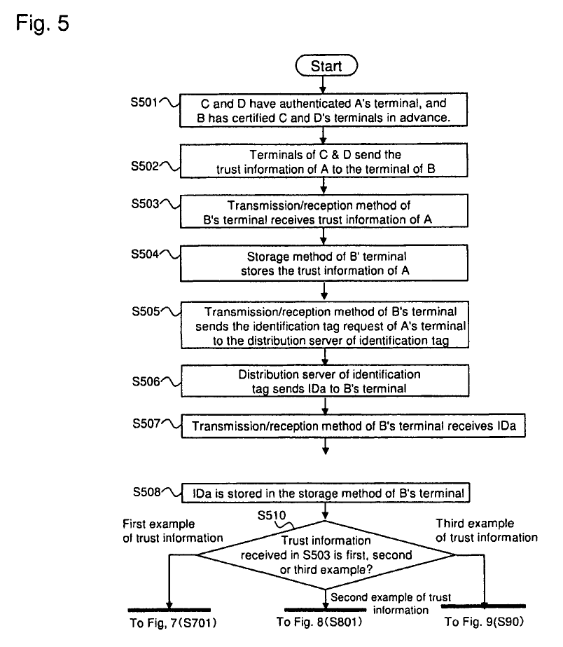

Each step of the method of an embodiment of the present invention for authenticating terminal 101 as a terminal of User A by User B's terminal 102 is explained with a reference to FIGS. 1 and 5. As described above, before starting the method of an embodiment of the present invention, Users C and D, in some way, authenticate terminal 101 as User A's terminal, and User B, in some way, authenticates terminals 103 and 104 as the terminals of Users C and D respectively (Step S501 in FIG. 5). Here, any authentication method can be used. For example, when User A is the direct acquaintance of C, User C communicates with User A through terminal 103 which has the identification tag IDc or through the network and also through terminal 101 which has the identification tag IDa by an e-mail, a voice communication, a video phone, a chat or an SNS (Social Network Service). In such a situation, it can be confirmed from the contents, voice, or images of communication that User C has communicated with User A. Further, it can be authenticated that the terminal 101 which has the identification tag IDa with which User C has communicated through the network, is the terminal of User A. In addition, User C can use the methods of the present invention to authenticate terminal 101 as the terminal of User A. What is described in this paragraph is similar for the case where User D also authenticates User A and User H.

In this state, User C's Terminal 103 sends the trust information 130, that is ‘User C has already authenticated the terminal 101 and the terminal 107 to User B's terminal 102 and User E's terminal 105, who are likely to authenticate the users who have already been authenticated by User C (Step S502) in future.

The trust information 130 sent from User C's terminal to the terminals of User B and E includes one of the three data structures described below.

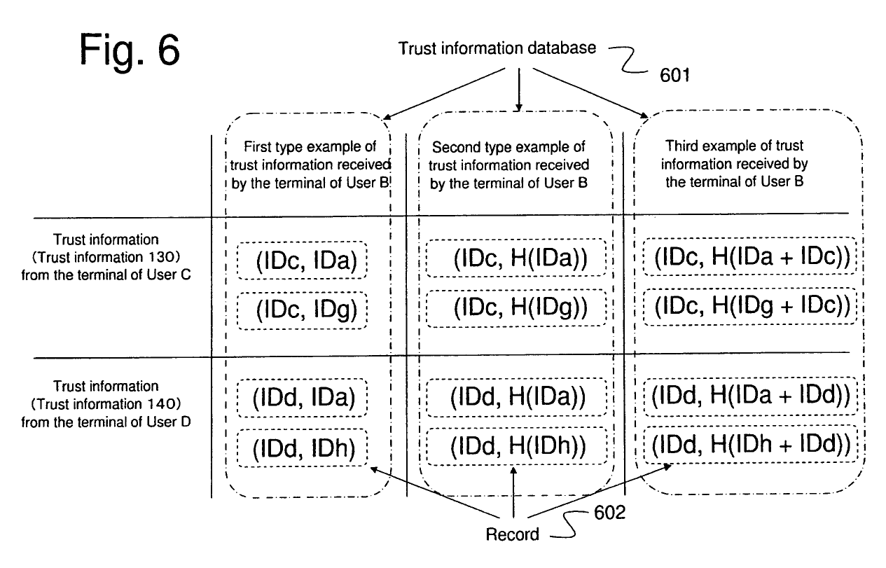

As shown in FIG. 6, the trust information 130 of the type of the first example includes two records (IDc, IDa) and (IDc, IDg). These records contain the identification tag IDc of User C and the identification tag IDa and IDg of the respective terminals of Users A and G that are authenticated by User C. The identification tags IDc, IDa, and IDg are all in the form of plain text here. In other words, “The terminal 101 which has the identification tag IDa is authenticated by User C, who is the owner of the terminal 103 which has the identification tag IDc” and “The terminal 107 is authenticated by User C, who is the owner of the terminal 103 which has identification tag IDc.”

As shown in FIG. 6, the trust information 130 of the type of the second example includes two records (IDc, H(IDa)) and (IDc, H(IDg)). These records contain the identification tag IDc of User C and the hash values H (IDa) and H (IDg) of the identification tags of the respective terminals of Users A and G that are authenticated by User C. In other words, “The terminal 101 which has the identification tag IDa is authenticated by User C, who is the owner of the terminal 103 which has the identification tag IDc” and “The terminal 107 is authenticated by User C, who is the owner of the terminal 103 which has the identification tag IDc.”

As shown in FIG. 6, the trust information 130 of the type of the third example includes two records (IDc, H(IDa+IDc)) and (IDc, H(IDg+IDc)). These records contain the identification tag IDc of User C, and hash values H (IDa+IDc) and H (IDg+IDc), which are the concatenations of the identification tags of Users A and G with the identification tag of User C. In other words, “The terminal 101 which has identification tag IDa is authenticated by User C, who is the owner of terminal 103 which has the identification tag IDc” and “The terminal 107 is authenticated by User C, who is the owner of the terminal 103 which has the identification tag IDc.”

Similarly, User D's Terminal 104 sends the trust information 140, that is, User D has already authenticated the terminal 101 and the terminal 108 to User B's terminal 102 and User F's terminal 106, who are likely to authenticate the users who have already been authenticated by User D (Step S502) in future.

The trust information 140 sent to the terminals of User B and User F from the terminal of User D includes one of the following three data structures.

The trust information 140 of the type of the first example includes two records (IDd, IDa) and (IDd, IDh) as shown in FIG. 6. Identification tags IDd, IDa, and IDh are all in the form of plain text here. These records are associated with the identification tag IDd of User D, and the identification tags IDa and IDh of the terminals of User A and User H authenticated by User D respectively. These records have the meaning of “User D, who is the owner of the terminal 104 with identification tag IDd, has authenticated terminal 101 which has identification tag IDa” and “ser D, who is the owner of the terminal 104 with identification tag IDd, has authenticated terminal 108 which has identification tag IDh” respectively.

The trust information 140 of the type of the second example includes two records of (IDd, H(IDa)) and (IDd, H(IDh)) as shown in FIG. 6. These are associated with the identification tag IDd of User D, and with the hash values H (IDa) and H (IDh) of the identification tag of the terminal of User A and the terminal of User H authenticated by User D respectively. Similar to the first example of the trust information 140 mentioned above, these records have the meaning of “User D, who is the owner of the terminal 104 with identification tag IDd has identified the terminal 101 which has identification tag IDa”, “User D, who is the owner of the terminal 104 with identification tag IDd has authenticated terminal 108 which has identification tag IDh” respectively.

The trust information 140 of the type of the third example includes two records of (IDd, H (IDa+IDd)) and (IDd, H (IDh+IDd)) as shown in FIG. 6. These are associated with the identification tag IDd of User D, and the hash values H (IDa+IDd) and H (IDh+IDd) associated with the identification tag of each terminal of User A and of User H and the identification tag of User D respectively. Similar to the trust information 140 of the type of the first or second example mentioned above, these records have the meaning of “User D, who is the owner of the terminal 104 with identification tag IDd has authenticated terminal 101 which has identification tag IDa”, “User D, who is the owner of the terminal 104 with identification tag IDd has authenticated terminal 108 which has identification tag IDh.”

Here, in the example shown in FIG. 6, symbol H (Z) in the trust information 130, 140 of the type of the second example and the trust information 130, 140 of the type of the third example indicates the hash value of information Z. The algorithm for generating the hash value may be MD5, SHA-1, SHA-2, or so on. The “+” symbol in the third example indicates the concatenation of two identification tags. However, in the method of an embodiment of the present invention, these two identification tags need not limited to be concatenated. They can also be calculated in any method based on two identification tags.

Moreover, in the examples shown in FIG. 1, FIG. 5, and FIG. 6, the terminal 102 of User B who is an authenticator obtains the trust information from the terminal 103 of User C and from the terminal 104 of User D. However, in the method according to an embodiment of the present invention, the terminal of User B who is an authenticator may receive the trust information from any number of terminals.

Furthermore, the transmission/reception device 403 of the terminal 102 of User B receives the trust information 130 and 140 that have been sent by the terminal of User C and by the terminal of User D at the above mentioned step S502 (Step S503) and stores these trust information in the storage device 404 as trust information database 601 (Step S504). The trust information data database 601 includes records 602.

Next, the transmission/reception device 403 of the terminal 102 of User B transmits a search request of the terminal 101 via the network to the identification tag distribution server 160 (Step S505). At least one piece of information related to User A that is stored in the terminal of User B may be included in the search request. Further, the identification tag distribution server 160 in response to this search request sends the identification tag IDa of the terminal 101 to the terminal 102 of User B via the network (Step S506). The transmission/reception device 403 of the terminal 102 of User B receives the identification tag IDa of the terminal 101 of User A (Step S507) and stores the identification tag in the storage device 404 (Step S508).

Furthermore, the trust information stored in the storage device 404 at Step S504, which has been received by the terminal of User B from each terminal of User C and User D, and the identification tag IDa of terminal 101 which has been stored in the storage device 404 at the above mentioned step S508 received by the terminal of User B from the identification tag distribution server are checked by using the following method. Further, the information essential in order for User B to identify the terminal 101 of User A is extracted.

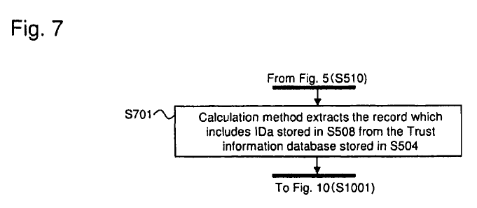

By referring to FIG. 7, at the above mentioned step S504, when the terminal 102 of User B receives the trust information 130 of the type of the first example and the trust information 140 of the type of the first example and stores it in the trust information database (Step S504), search part 405 of the terminal of User B extracts the record that includes the identification tag IDa stored at the above mentioned step S508 (Step S701) from the previous mentioned trust information database stored in the storage device 404. Here, two records of (IDc, IDa) and (IDd, IDa) that include IDa are extracted by the search part 405 since the trust information 130 of the type of the first example includes two records of (IDc, IDa) and (IDc, IDg), and the above mentioned trust information 140 of the type of the first example includes two records of (IDd, IDa) and (IDd, IDh).

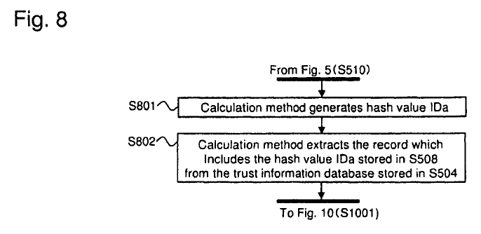

By referring to FIG. 8, at the above mentioned step 504, when the terminal 102 of User B receives the above mentioned trust information 130, 140 of the type of the second example, the calculation part 402 calculates (Step S801) the hash value H (IDa) from the identification tag IDa of User A which is stored in the storage device 404 at the above step S508 and extracts (Step S802) the record that includes the above hash value H(IDa) from the above mentioned trust information database that is stored in the storage device 404 at the previous step S504. Here, two records of (IDc, H(IDa)) and (IDd, H(IDa)) that include H(IDa) are extracted by the search part 405 since the above mentioned trust information 130 of the type of the second example includes two records of (IDc, H(IDa)) and (IDc, H(IDg)), and the above mentioned trust information 140 of the type of the second example includes two records of (IDd, H(IDa)) and (IDd, H(IDh)).

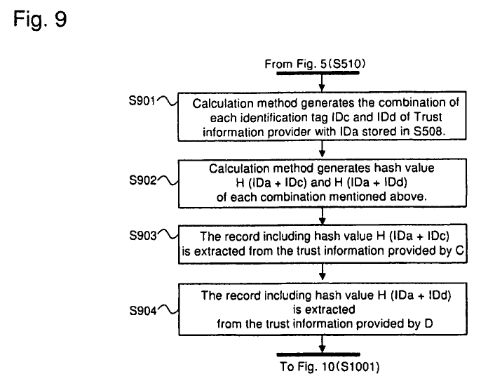

At the above-mentioned step S504, when the terminal 102 of User B receives the trust information 130, 140 of the type of the third example mentioned above, as shown in FIG. 9, the calculation part 402 calculates IDa+IDc and IDa+IDd (Step S901), which is the combination of the identification tag IDa of User A stored in the storage device 404 at Step S508 mentioned above, and the identification tag IDc of User C as well as the identification tag IDd of User D, which are already stored in the storage device 404 and then calculates the hash values H (IDa+IDc) and H (IDa+IDd) (Step S902). Next, at Step S504, from the trust information database stored in the storage device 404, a record, which includes the above-mentioned hash value H (IDa+IDc), is extracted from the trust information received by the terminal 103 of User C (Step S903). Similarly, at above-mentioned step S504, from the trust information database stored in the storage device 404, a record, which includes H (IDa+IDd) received from the terminal 104 of User D is extracted. Since two records (IDc, H (IDa+IDc)) and (IDc, H (IDg+IDc)) are included in the trust information 130 of the type of the third example and two records (IDd, H (IDa+IDd)) and (IDd, H (IDh+IDd)) are included in the trust information 140 of the type of the third example, here, the search part 405 extracts two records (IDc, H (IDa+IDc)) and (IDd, H (IDa+IDd).

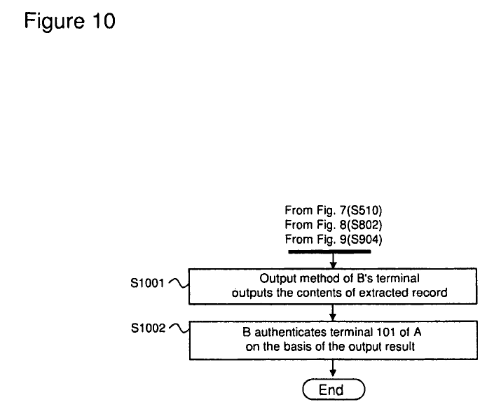

As shown in FIG. 10, the output device 401 of User B's terminal outputs the following two pieces of information (Step S1001) based on these extracted records. The first information shows the fact that User C has authenticated the terminal 101 by the terminal 103, which is already authenticated by User B. Further, the second information shows the fact that User D has authenticated the terminal 101 by the terminal 104, which is already authenticated by User B. The identification tags IDa, IDc, and IDd of User A, C and D may be directly output along with some information related to User A, User C, and User D tagged with respective identification tags in the terminal 102 of User B. For example, it may be displayed that “The owner of IDc has authenticated the terminal which has the identification tag IDa.” If the names of User C and of User A are stored in the storage device 404 of User B's terminal and if these are tagged with respective identification tags IDc and IDa, then it can be output that “User C has authenticated the terminal which has the identification tag IDa as User A's terminal.” This is one example of output and according to the methods of an embodiment of the present invention; the output at Step 1001 is not limited to only this example.

Next, at the above-mentioned step S1001, User B uses the above-mentioned two pieces of information which are output from the output device 401 of User B's terminal 102, in order to authenticate that the terminal having the identification tag IDa obtained at the above-mentioned step S507 belongs to User A (Step S1002).

In the explanation given so far, the events where User C and User D use their terminals to authenticate terminal 101 as User A's terminal, or where User B authenticates the terminal 103 of User C and the terminal 104 of User D (Step S501), and where User B authenticates the terminal 101 of User A by using the information that is output by the output device 301 of the terminal 104 (Step S1002), are mental activities of the users and are not included in the scope of the present invention. One aspect of the present invention provides a method for easily judging User B by communicating at Step S501 the fact that User C and User D have authenticated the terminal 101 as User A's terminal to the terminal 102 of User B automatically and confidentially.

Here, when the terminal 102 of User B displays the trust information at the above-mentioned step S1001, the only requirement of an embodiment of the present invention is that, the information related to User A obtained by the terminal 102 of User B should include the identification tag. The identification tag in an embodiment of the present invention may be any tag as long as it uniquely identifies a user on the network. At the above mentioned step S1001, when the output device 401 of User B's terminal displays that “The owner of IDc has authenticated the terminal which has identification tag IDa”, User B obtains only this factual information from this display, and they may or may not obtain any other information about the owner of the terminal which has identification tag IDa. In other words, when User C and D authenticate the terminal 101 which has the identification tag IDa as User A's terminal, the terminal 102 of User B only needs to know the fact that User C and User D have authenticated the terminal with the identification tag IDa, and it may or may not know whom the terminal 101 belongs to. The event that the terminal of User B receives the information that User C and User D have authenticated User A as the user of terminal 101, and the event that the terminal of user B receives any information of user A are independent. As one aspect of the present invention, the method which uses the former event as the means of authentication is provided. For example, (IDc, IDa), (IDc, H (IDa)), or (IDc, H (IDc+IDa)), etc. included in the trust information indicates the fact that User C has authenticated the terminal which has the tag IDa as User A, and the information such as the name of the user etc. may or may not be included in this trust information. When this information is included in the trust information, in addition to these records, the trust information where the information of User A is associated with IDa may also be received. Event though this information is not included in the trust information, either the fact that User B already has that information in the storage device after receiving IDa from the identification tag distribution server, or the fact that the information is stored in the storage device after tagging IDa to User A's information received via the network, may be output at the above-mentioned step S1001.

In this way, according to an embodiment of the present invention, when Users A and B do not have each other's personal information, it is possible to disclose their personal information to each other more safely after User B authenticates the terminal which has identification tag IDa and User A authenticates the terminal which has identification tag IDb by using the method of an embodiment of the present invention.

Particularly, according to an embodiment of the present invention, since the authenticator can authenticate the terminal of the authenticatee by referring to the number of authentication results by direct acquaintances who have been also authenticated, the high-level authentication can be propagated over the entire network.

The advantages of an embodiment of the present invention regarding the three examples of the trust information mentioned above are described below.

At the above-mentioned step S504, in the trust information of the type of the first example that is received and stored by the terminal 102 of User B from the terminals of User C and of User D, each record of the trust information database contains attached identification tags of the trust information provider and authenticatee as plain texts. For example, information that User C, who is a trust information provider, has authenticated terminal 101 is described in the record (IDc, IDa).

However, one problem in the trust information of the type of the first example is that, the terminal of the authenticator receives the information that the identification tags of the trust information provider and the authenticatee are attached in the state of plain text. Thus, the authenticator obtains the information of the personal relationship between the trust information provider and the authenticatee included in the trust information. Such information of the personal relationship is not required for the authentication. For example, referring to FIG. 6 in the trust information of the type of the first example, the terminal 102 of User B receives a total of four records namely (IDc, IDa) and (IDc, IDg) from terminal 103 of User C and (IDd, IDa) and (IDd, IDh) from terminal 104 of User D. Since the all identification tags included here are in plain text, User B can recognize from its terminal 102 that Users C, A and G, or Users D, A and H are acquaintances. Generally, the direct acquaintance between users is personal confidential information. In the methods of the present invention, the personal information between Users C and G, Users D and H, which is not required by User B for authenticating User A need not be sent to User B.

The problem with regard to the trust information of the type of the first example can be solved by using the trust information of the type of the second example mentioned above. In the above mentioned trust information of the type of the second example, each record of the trust information database contains the hash values of identification tags of the trust information provider and authenticatee. For example, the information that User C has authenticated terminal 101 as User A's terminal is described in record (IDc, H (IDa)). Referring to FIG. 6 again, in the trust information of the type of the second example, the search part 405 of the terminal 102 of User B includes H (IDa) and hence extracts (IDc, H (IDa)) and (IDd, H (IDa)) (Step S802). As a result, the terminal 102 of User B outputs the fact that User C and D has authenticated terminal 101 as User A's terminal (Step S1001). However, in the trust information of the type of the second example, the information received by the terminal 102 of User B from the trust information provider is only the record that includes the hash values and not the identification tag IDa of authenticatee. Therefore, there is no way by which User B can recognize the fact that the Users C and D have authenticated the terminal which has IDa as User A's terminal unless the terminal 102 of User B obtains the identification tag IDa from the identification tag distribution server 160. In addition, there is no way by which User B can recognize that User C has the direct acquaintance with User G, and User D has the direct acquaintance with User H, with the help of the remaining two records (IDc, H(IDg)) and (IDd, H(IDh)), which are not extracted even after the terminal of User B obtains the identification tag IDa. In this way, the problem with regard to the trust information of the type of the first example, where User B, the authenticator, obtains the trust information of User C and D, who are trust information providers, which includes their personal information i.e. their relationship with other users, is solved. This is one of the advantages of an embodiment of the present invention.

But, there is a problem that cannot be solved in the trust information of the type of the second example. For example, the authenticator can obtain the fact that there is a common acquaintance for more than two trust information providers. This is because a particular identification tag always has the same hash value. In addition to the relationship shown in FIG. 1, consider that User X is a common acquaintance of User C and User D, and both User C and D authenticate X's terminal. Then in this case, (IDc, H(IDx)) is included in the trust information of the type of the second example sent to terminal 102 of User B from the terminal 103 of User C, and (IDd, H(IDx)) is included in the trust information of the type of the second example sent to the terminal 102 of User B from the terminal 104 of User D. Even if the search part 405 of the terminal 102 of User B that receives this information, searches the record that includes H (IDx), there is no way by which User B can recognize that the owner of identification tag IDx is the common acquaintance of User C and D. However, even if the particular user cannot be identified, from the fact that H (IDx) is included in both of these records, it is possible for User B to recognize the fact that there is a common acquaintance between User C and User D. In some cases, it is preferable to keep such facts confidential.

The problem with regard to the trust information of the type of the second example can be solved by using the trust information of the type of the third example mentioned above. In the trust information of the type of the third example, each record of the trust information database is the hash value of the identification tag of the trust information provider, and the concatenation of identification tags of the authenticatee and trust information provider. For example, the information that User C has authenticated terminal 101 as User A's terminal, is described in the record (IDc, H (IDa+IDc)). Once again referring to FIG. 6, where in the trust information of the type of the third example, the identification tag IDc of the information provider that is stored at Step S501, and the identification tag IDa of the authenticatee that is stored at Step S508 are stored in the storage device of the terminal 102 of User B. Therefore, the calculation part of the terminal 102 of User B can calculate H (IDa+IDc). Hence, the search part 405 of the terminal 102 of User B can extract the above-mentioned (IDc, H(IDa+IDc)) (Step S903), and output the fact that User C has authenticated terminal 101 of User A.

In addition to the relationship shown in FIG. 1, consider that User X is a common acquaintance of User C and User D, and User X is authenticated by the terminals of User C and User D. Then in this case, (IDc, H(IDc+IDx)) is included in the trust information of the type of the third example sent to the terminal 102 of User B from the terminal 103 of User C, and (IDd, H(IDd+IDx)) is included in the trust information of the type of the third example sent to the terminal 102 of User B from the terminal 104 of User D. Presently, the identification tag IDx of User X cannot be directly extracted in the storage device 404 of User B's terminal, which is trying to authenticate the terminal 101 of User A. Hence, the search part 405 of User B's terminal cannot identify that H(IDc+IDx) and H(IDd+IDx) is the authenticated information of User X, who is the authenticatee. Thus, by using the trust information of the type of the third example mentioned above, the authenticator does not even know that there is a common acquaintance between more than two authentication information providers. This is one of the advantages of an embodiment of the present invention.

In this way, in the method of an embodiment of the present invention, the terminal of the authenticator obtains the information that a provider of the authenticated trust information has authenticated the terminal of the authenticatee. Further, when the authenticator's terminal obtains the authenticatee's identification tag from the authentication tag distribution server, it can authenticate the authenticatee by using the trust information mentioned previously. At this time, in the trust information obtained from the trust information provider, by using the trust information of the type of the second example mentioned above instead of using the trust information of the type of the first example, the authenticator can be prevented from identifying the acquaintances of the trust information provider. Moreover, in the trust information obtained from the trust information provider, by using the trust information of the type of the third example mentioned above instead of using the trust information of the type of the second example, the authenticator can be prevented from identifying the acquaintance of the trust information providers and the possibility to know that there are common acquaintances between various trust information providers.

### EMBODIMENT 2

In the embodiment 1 explained above, the trust information provider conveys to the authenticator's terminal that the trust information provider authenticates the terminal which has a specific identification tag as the authenticatee's terminal, by using the trust information of the type of the first, second, or third example. In the embodiment 2, in addition to this, the relationship of the trust information provider with the authenticatee, or the personal information of the authenticatee, who is known to the trust information provider, is added to the trust information as additional information, and thus as compared to embodiment 1, the authenticator can execute a high-level authentication for the authenticatee.

Further, all the steps given in the embodiment 2 that are executed by the respective components, are similar to those explained in the embodiment 1. Only the contents of the trust information that are sent from the terminal of the trust information provider to the terminal of the authenticator are different. Therefore, in the description of the embodiment 2 given below, the description of the execution of all the steps is omitted since it is given in the embodiment 1. Only the contents of the trust information, it's processing and advantages are described.

In the embodiment 2, referring to FIG. 1, the trust information 130 sent at Step S502 from the terminal of User C, who is a trust information provider, to the terminals of User B and E, who are authenticators, includes either of the three structures given below.

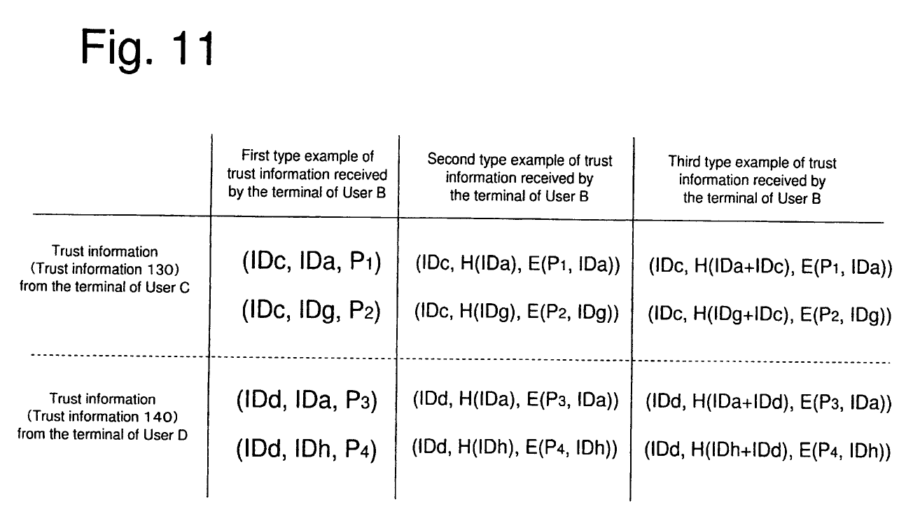

The trust information 130 of the type of the first example of embodiment 2 includes two records (IDc, IDa, P1) and (IDc, IDg, P2) as shown in FIG. 11. For example, for (IDc, IDa, P1), additional information P1 is attached to the identification tag IDc of User C, who is a trust information provider, and to the identification tag IDa of User A, who is the authenticatee, with their respective plain text. The additional information P1 may be any information such as relationship between User C and User A, or personal information of User A, who is known to User C etc., required by User B, the authenticator, for authenticating the terminal 101 of User A as given at Step 1002. For example, P1 can be a string of the name of User A, or it can be a string “a classmate in school”, or it can also be a code indicating the relationship between various users that is already defined. If the string “a classmates in school” is used as additional information P1, then the above-mentioned (IDc, IDa, P1) implies “User C has authenticated terminal 101 which has the identification tag IDa as a classmates in school”.

The trust information 130 of the type of the second example in the embodiment 2 includes two records (IDc, H(IDa), E(P1, IDa)) and (IDc, H(IDg), E(P2, IDg)) as shown in FIG. 11. For example, regarding to (IDc, H(IDa), E(P1, IDa)), the result E(P1, IDa) of encrypting additional information P1 with the identification tag IDa is added to the identification tag IDc of User C, who is a trust information provider, and to the hash value H(IDa) of the identification tag of User A, who is the authenticatee. Similar to the trust information of the type of the first example, the additional information P1 may be any information such as relationship between User C and User A, or personal information of User A, who is known to User C, required by User B, who is the authenticator, for authenticating the terminal 101 of User A as given at Step 1002.

The trust information 130 of the type of the third example of the embodiment 2 includes two records (IDc, H (IDa+IDc), E (P1, IDa)), and (IDc, H (IDg+IDc), E (P2, IDg)) as shown in FIG. 11. For example, (IDc, H (IDa+IDc), E (P1, IDa)) is the association of the following three data. The first is the identification tag IDc of User C, who is a trust information provider. The second is the hash value H(IDa+IDc) which is the combination of the identification tag IDa of the User A, who is the authenticatee. And the third is E(P1, IDa) which is the result of the encryption of additional information P1 by using the identification tag IDa. Similar to the above-mentioned trust information of the types of the first and second examples, here, if the additional information P1 such as the relationship between User C and User A or personal information of User A that User C knows, may be useful information for User B, who is the authenticator, for authenticating the User A's terminal 101 at above-mentioned step 1002.

Further, in the embodiment 2, referring to the example shown in FIG. 1, similar to the above-mentioned trust information 130, the trust information 140 sent from the terminal of User D, who is the trust information provider, at above-mentioned step S502 to the terminal of User B and User F, who are the authenticators, includes either of the three types of the trust information shown in FIG. 11.

In the example shown in FIG. 11, Symbol E (Y, Z) shown in the trust information 130 and 140 of the types of the second and third examples indicates the information where information Y is encrypted by using the secret key Z. Encryption algorithm may be DES, tri-DES, AES, RC6, CAST-128, or so on. Symbol H(Y) shown in the above-mentioned trust information 130 and 140 of the types the second example and the third examples indicates the hash value of information Y. The algorithm for generating a hash value may be MD5, SHA-1 SHA-2, or so on. The “+” sign shown in the third example indicates the concatenation of two identification tags. However, the method represented by “+” of this embodiment of the present invention is not limited to the concatenation of two identification tags, but any calculation of two identification tags may be allowed.

Further, the trust information, which User B's terminal receives from the terminals of User C and User D and which is stored in the storage device 404 at Step S504 in the embodiment 2, and the identification tag IDa of terminal 101 of User A, which User B's terminal receives from the identification tag distribution server and which is stored in the storage device 404 at Step S508 in the embodiment 2, are checked by using the following method for example. User B extracts the information required to authenticate User A's terminal 101.

At Step S504 of the embodiment 2, when User B's terminal 102 receives the above-mentioned trust information 130 of the type of the first example and the above-mentioned trust information 140 of the type of the first example, and stores the information in the trust information database, then the calculation part 402 of the terminal of User B extracts from the trust information database the records containing the identification tag IDa of User A, which has been stored at Step S508 in the embodiment 2 (Step S701 in the embodiment 2). In the case of the embodiment 2, since the records contain additional information, the output device of terminal 102 of User B outputs the contents of extracted records containing this additional information. For example, if the above-mentioned (IDc, IDa and P1) are extracted and the string “a classmate since the high school N” is used as additional information P1, then the above-mentioned output method 401 of User B outputs the information “User C has authenticated terminal 101 which has identification tag IDa as a classmate since the high school N” (Step S1001).

At Step S504 of the embodiment 2, when User B's Terminal 102 receives the above-mentioned trust information 130 of the type of the second example and the above-mentioned trust information 140 of the type of the second example, and stores the information in the trust information database, then the calculation part 402 of the terminal of User B extracts from the trust information database the records containing hash value H(IDa) of the identification tag IDa of User A, which has been stored at Step S508 in the embodiment 2 (Step S802 in embodiment 2). In the embodiment 2, since this record contains the additional information, which is encrypted by using the identification tag IDa of the person to be authenticated, the calculation part 402 of the terminal of User B decrypts the information that is encrypted by using the identification tag IDa as a secret key stored in the storage device 404 at Step S508 of the embodiment 2. For example, additional information P1 of E(P1, IDa) included in the extracted record (IDc, H(IDa), E(P1, IDa)) is decrypted by the calculation part 402 of the terminal of User B which has IDa as the secret key. Here, if the string “a classmate from the high school A” is used as additional information P1, then the above-mentioned output method 401 of User B outputs the information “User C has authenticated terminal 101 which has the identification tag IDa as a classmate in school days” (Step S1001).

At Step S504 of the embodiment 2, when User B's terminal 102 receives the above-mentioned trust information 130 of the type of the third example and stores it in the trust information database, the calculation part 402 of the terminal of User B searches the records containing the hash value H (IDa+IDc), which is the concatenation of the identification tag IDa stored at Step S508 of the embodiment 2 and the identification tag IDc of User C, who is the trust information provider. Similarly, when the above-mentioned trust information 140 of the type of the third example is received and stored in the trust information database, the records containing the hash value H (IDa+IDd) are searched (Step S802 of the embodiment 2). In the embodiment 2, since these records contain additional information, which is encrypted by using the identification tag IDa of the person to be searched, the calculation part 402 of the terminal of User B decrypts the information that is encrypted by using the identification tag IDa as a secret key stored in the storage device 404 at Step S508 of the embodiment 2. For example, the additional information P1 and P3 of E (P1, IDa) and E (P3, IDa) included in the extracted records (IDc, H (IDa+IDc), E (P1, IDa)) and (IDd, H (IDa+IDd), E (P3, IDa)) respectively are decrypted by the calculation part 402 of the terminal of User B which has IDa as the secret key. Here, if the string “a classmate from the high school A” is used as the additional information P1, the output device 401 of User B outputs the information “User C has authenticated the terminal 101 which has the identification tag IDa as a classmate in the high school A”. For example, if the string “a sibling” is used as P3, the output device 401 of User B outputs the information “User D has authenticated the terminal 101 which has identification tag IDa as a sibling” (Step S1001 of the embodiment 2).

As explained above, User B can authenticate the terminal which has the identification tag IDa as User A's terminal on the basis of information output from the output device 401 of User B's terminal (Step S1002 in the embodiment 2). In the description of the embodiment 2, the following actions are not considered since these are mental activities of each User: 1) User C and User D use their respective terminals to authenticate terminal 101 as the terminal of User A; 2) User B authenticates terminal 103 as the terminal of User C and terminal 104 as the terminal of User D (Step S501 in the embodiment 2); and 3) User B authenticates terminal 101 as the terminal of User A by using the information output from the output method 301 of its terminal by using the method of this invention (Step S1002 in the embodiment 2). This invention provides a method by which the fact that User C and User D have authenticated the terminal of User A at the above-mentioned step S501, is transmitted to the terminal 102 of User B so that judgment by User B becomes easy.

The additional advantage of this embodiment 2, compared to the embodiment 1 is that User B can authenticate the terminal which has the identification tag IDa at a higher level on the basis of information output from the output device 401 of the User B's terminal at the previously mentioned step S1002 of the embodiment 2. At Step S1001 of the embodiment 2, the relationship of User A, who is the authenticatee, with User C or User D, who are the trust information providers, or the information of authenticatee known to the trust information providers is disclosed as the additional information to User B, who is the authenticator. As a result of this, User B can assume from the additional information that the terminal which has the identification tag, which is the authentication target of the trust information provider, belongs to the authenticatee. For example, the authentication of the additional information “a family member” is of a higher level than “a friend on SNS.” Moreover, when User A, who is the authenticatee, has common acquaintances as User B, the authenticator, as in previously mentioned FIG. 1, the authenticator can judge whether the authenticatee is the actual person themselves, on the basis of various additional information, and hence the level of authentication increases. For example, when the information “User D is authenticating User A as a friend in the high school A, and User C is authenticating User A as a family member” is output from the output device of the terminal of User B, who is the authenticator, User B can authenticate User A at a higher level as compared to the previously mentioned embodiment 1. Thus, in embodiment 2, it is easy for the authenticator's terminal to judge the level of authentication by transmitting the fact that, the trust information provider is authenticating the terminal, along with the additional information.

Further, the effects of the trust information of the type of the first, second, and third example in the embodiment 2 is examined below.

The problem of the trust information of the type of the first example in the embodiment 2 is that, since the terminal of the authenticator receives the additional information about the authenticatee from the trust information provider in plain text, the authenticator can also obtain the information which is not required for authentication. For example, in FIG. 11, as shown as the e trust information of the type of the first example, User B's terminal 102 receives all four records (IDc, IDa, P1) and (IDc, IDg, P2) from User C's terminal 103, and (IDd, IDa, P3) and (IDd, IDh, P4) from User D's terminal 104. Here, if the additional information P2 is the information “a colleague in company”, User B, who is the authenticator, can obtain the information from the terminal 103 that User C and User G, who are not related to the authentication of User A, are company colleagues. Generally, the type of relationship between users is confidential personal information. In the methods of the embodiment 2 of the present invention, according to Users C and D, who are the trust information providers, the personal information, which is not required by User B for authenticating User A, need not be sent to User B.

The problem of the trust information of the type of the first example in the embodiment 2 can be solved by using the trust information of the type of the second example in the previously mentioned embodiment 2. In the trust information of the type of the second example, the additional information in each record of the trust information database is encrypted by using the identification tag of each authenticatee's terminal as a secret key. For example, in the trust information of the type of the second example, the terminal 102 of User B, who is the authenticator, obtains two records (IDd, H(IDa), E(P3, IDa)) and (IDd, H(IDh), E(P4, IDh)) from User D, who is the trust information provider. When Step S508 is completed, User B's terminal 102 can decrypt the additional information P3 of the previous record by using the identification tag IDa stored in the storage device. However, User B cannot decrypt the additional information P4 since User B does not have the identification tag IDh of User H. Consequently, User B cannot obtain from trust information 140, the information such as relationship between User D and User H, which is not required for the authentication of the terminal which has the identification tag IDa, and User B cannot obtain the information of User H which User D knows. Thus the problem of the trust information of the type of the first example in embodiment 2 is avoided.

However, as mentioned in the embodiment 1, with regard to even the trust information of the type of the second example of the embodiment 2, there is a problem that the authenticator can obtain the information that two or more trust information providers have a common acquaintance. This is because the same hash value is always calculated using the same identification tag. Therefore, as shown with regard to the trust information of the type of the third example, each record in the trust information database consists of the identification tag of a trust information provider, and the hash value of the combination of the identification tags of the authenticatee and the identification tags of the trust information provider. Hence, a common acquaintance cannot be detected, and the additional information is not obtained, unless the terminal of the searcher obtains the identification tag of a corresponding authenticatee.

### EMBODIMENT 3

With regard to the first, the second, or the third example in the above-mentioned embodiment 2, the trust information provider transmits the fact related to the authenticator's terminal that the trust information provider has authenticated the terminal of the authenticatee, and provides the additional information related to that authentication. In the embodiment 3 of the present invention, flag information such as whether to trust the information or not is added. As compared to the embodiment 2, the method of the embodiment 3 of the present invention enables the authenticator to perform an even higher-level of authentication.

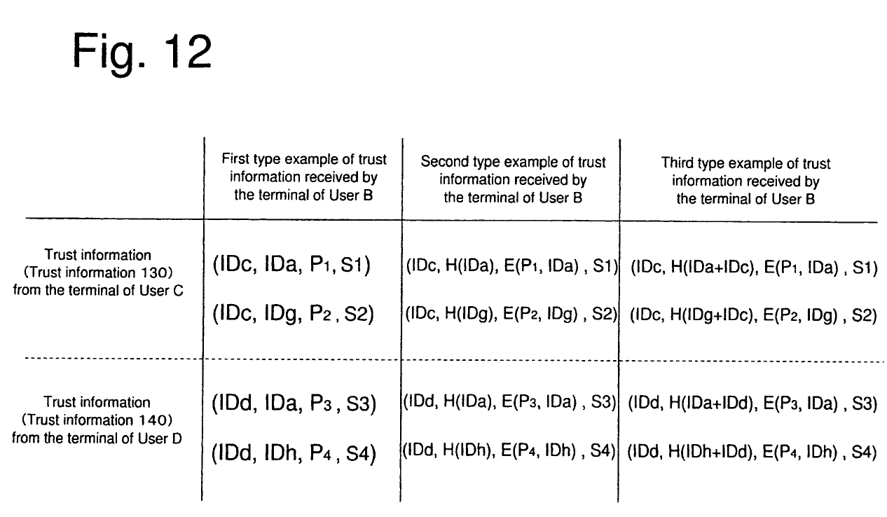

Referring to FIG. 12, at Step S502 of the embodiment 3, each record shown in FIG. 11 of the trust information 130 and 140, which is sent to User B's terminal by the respective terminals of User C and User D, also includes flag information Sn, where n is an integer. In embodiment 3, this flag information indicates either “the terminal which has a corresponding identification tag is authenticated as the terminal of the actual authenticatee himself or herself” or “the terminal which has a corresponding identification tag is not the terminal of the authenticatee himself or herself.” For example, the flag is set to Sn=1, if it is the authenticatee's terminal, otherwise it is set to Sn=−1.

For example, referring to FIG. 12, with regard to the trust information 140 of the type of the second example, since User D, the trust information provider, has authenticated the terminal which has the identification tag IDa as the terminal of User A, S3=1 in (IDc, H(IDa), E(P3, IDa), S3), and since User D has judged that the terminal which has the identification tag IDh is not the terminal of User H, S4=−1 in (IDd, H(IDh), E(P4, IDh), S4). Further, P3 as “a family member” and P4 as “a friend” are provided as additional information. In such a case, the terminal 102 of User B, the authenticator, obtains the identification tag IDa of the authenticatee from the identification tag distribution server 160 at Step S507. Further at Step S802, the calculation part 402 extracts the record which has the hash value H(IDa), and obtains the additional information P3 after decrypting E(P3, IDa) by considering the identification tag IDa as secret key. Since S3=1 in the record (IDc, H(IDa), E(P3, IDa), S3), the output device 401 outputs the information “User D has authenticated the terminal which has the identification tag IDa as a family member” at Step S1001. User B uses this output as positive authentication information to authenticate the terminal which has the identification tag IDa as the terminal of User A.

On the other hand, User B's terminal, the authenticator, obtains the identification tag IDh from the identification tag distribution server 160. Also in this case, the output device 401 outputs the contents of record (IDd, H(IDh), E(P4, IDh), S4) in the same way. In this case, since S4=−1, the output is “User D has judged that the terminal which has the identification tag IDh is not the terminal of the actual authenticatee himself or herself to be authenticated as a friend.” User B uses this output as negative authentication information to authenticate the terminal which has the identification tag IDh as the terminal of User H.

An additional advantage of the embodiment 3 as compared to the embodiment 1 and the embodiment 2 is that the authenticator can use not only the positive trust information related to the authenticatee, in other words the information that the trust information provider, who is already authenticated by the authenticator, has authenticated the authenticatee's terminal, but also the negative trust information related to the authenticatee, in other words the information that the trust information provider, who is already authenticated by the authenticator, has judged that the authenticatee's terminal is not the actual authenticatee himself or herself, in order to authenticate the terminal of the authenticatee. Thus, a high-level authentication can be executed with regard to the authenticatee.

The above described embodiments show several examples in which trust information includes a one of several forms of identification tags. In one form, trust information includes an identification tag as is, in another form, trust information includes a calculation result based on an identification tag such as a hash value. Forms of identification tags included in trust information are not limited to those described above.

What is claimed is:

1. An information terminal comprising:
a first receiver, the first receiver receiving trust information from a trust information provider, the trust information including identification information of a terminal belonging to an authenticatee, the trust information showing that the terminal belonging to the authenticatee is authenticated by the trust information provider;
a storage device, the storage device storing the trust information;
a second receiver, the second receiver receiving an identification tag of the terminal belonging to the authenticatee from a server; and
an outputting device, the outputting device outputting information for performing an identification judgment of the terminal belonging to the authenticatee based on the identification tag of the terminal belonging to the authenticatee and the trust information stored in the storage device.

2. The information terminal according to claim 1, wherein the identification information includes an identification tag of the terminal belonging to the authenticatee, and the trust information includes an identification tag of a terminal belonging to the trust information provider.

3. The information terminal according to claim 1, wherein the identification information includes a hash value of an identification tag of the terminal belonging to the authenticatee.

4. The information terminal according to claim 1, wherein the identification information includes a calculation result of an identification tag of the terminal belonging to the authenticatee and an identification tag of a terminal belonging to the trust information provider or a hash value of the calculation result.

5. The information terminal according to claim 1, wherein the identification information includes an identification tag of the terminal belonging to the authenticatee and the trust information includes additional information which is added when the authenticatee is authenticated by the trust information provider.

6. The information terminal according to claim 1, wherein the identification information includes an identification tag of the terminal belonging to the authenticatee and the trust information includes encrypted information which encrypts additional information which is added when the authenticatee is authenticated by the trust information provider, the identification tag of the terminal belonging to the authenticatee being used as an encryption key.

7. The information terminal according to claim 1, wherein the identification information includes a hash value of an identification tag of the terminal belonging to the authenticatee and the trust information includes encrypted information which encrypts additional information which is added when the authenticatee is authenticated by the trust information provider, the identification tag of the terminal belonging to the authenticatee being used as an encryption key.

8. The information terminal according to claim 1, wherein the identification information includes an identification tag of the terminal belonging to the authenticatee and the trust information includes a calculation result of the identification tag of the terminal belonging to the authenticatee and an identification tag of a terminal belonging to the trust information provider or a hash value of the calculation result and encrypted information which encrypts additional information which is added when the authenticatee is authenticated by the trust information provider, the identification tag of the terminal belonging to the authenticatee being used as an encryption key.

9. The information terminal according to claim 2, wherein the trust information further includes flag information which expresses whether the terminal belonging to the authenticatee is authenticated by the trust information provider or not.

10. An information terminal comprising:
a first receiver, the first receiver receiving identification information of a terminal belonging to an authenticatee;
a storage device, the storage device storing the identification information of the terminal belonging to the authenticatee;
a second receiver, the second receiver receiving trust information which includes an identification tag of the terminal belonging to the authenticatee, the trust information showing that the terminal belonging to the authenticatee is authenticated by a trust information provider; and
an outputting device, the outputting device outputting information for performing an identification judgment of the terminal based on the trust information and the identification information stored in the storage device.

11. The information terminal according to claim 10, wherein the identification information includes an identification tag of the terminal belonging to the authenticatee and the trust information includes an identification tag of a terminal belonging to the trust information provider.

12. The information terminal according to claim 10, wherein the identification information includes a hash value of an identification tag of the terminal belonging to the authenticatee.

13. The information terminal according to claim 10, wherein the identification information includes a calculation result of an identification tag of the terminal belonging to the authenticatee and an identification tag of a terminal belonging to the trust information provider or a hash value of the calculation result.

14. The information terminal according to claim 10, wherein the trust information includes an identification tag of the terminal belonging to the authenticatee and the trust information includes additional information which is added when the authenticatee is authenticated by the trust information provider.

15. The information terminal according to claim 10, wherein the identification information includes an identification tag of the terminal belonging to the authenticatee and the trust information includes encrypted information which encrypts additional information which is added when the authenticatee is authenticated by the trust information provider, the identification tag of the terminal belonging to the authenticatee being used as an encryption key.

16. The information terminal according to claim 10, wherein the identification information includes a hash value of an identification tag of the terminal belonging to the authenticatee and encrypted information which encrypts additional information which is added when the authenticatee is authenticated by the trust information provider, the identification tag of the terminal belonging to the authenticatee being used as an encryption key.

17. The information terminal according to claim 10, wherein the identification information includes a calculation result of an identification tag of the terminal belonging to the authenticatee and an identification tag of a terminal belonging to the trust information provider or a hash value of the calculation result and encrypted information which encrypts additional information which is added when the authenticatee is authenticated by the trust information provider, the identification tag of the terminal belonging to the authenticatee being used as an encryption key.

18. The information terminal according to claim 11, wherein the trust information further includes flag information which expresses whether the terminal belonging to the authenticatee is authenticated by the trust information provider or not.

19. A method for providing information electronically over a network which comprises:
receiving trust information, the trust information including a hash value of an identification tag of a terminal belonging to an authenticatee, and including an identification tag of a terminal belonging to a trust information provider;
storing the trust information as a trust information database record in a storage device;
receiving the identification tag of the terminal belonging to the authenticatee from a server;
generating a specific hash value by a calculation part, the specific hash value being generated based on the identification tag of the terminal belonging to the authenticatee;
searching a record from the storage device by a search operation part, the record including the specific hash value; and
performing an identification judgment of the terminal belonging to the authenticatee based on the identification tag of the terminal belonging to the trust information provider, the identification tag being included in the searched record.

20. A method of providing information electronically over a network, which comprises;
receiving trust information which includes a calculation result of an identification tag of a terminal belonging to an authenticatee and an identification tag of a terminal belonging to a trust information provider or a hash value of the calculation result;
storing the trust information as a trust information database record in a storage device;
receiving the identification tag of the terminal belonging to the authenticatee from a server;
generating a specific calculation result by a calculation part based on the identification tag of the terminal belonging to the authenticatee and the identification tag of the terminal belonging to the trust information provider;
searching a record from the storage device by a search operation part, the record including the calculation result; and
performing an identification judgment of the terminal belonging to the authenticatee based on the identification tag of the terminal belonging to the trust information provider, the identification tag being included in the searched record.

21. A method for providing information electronically over a network, which comprises;
receiving trust information which includes a calculation result, the calculation result being an encryption of additional information which is added when a terminal belonging to an authenticatee is authenticated by a trust information provider, and an identification tag of the terminal belonging to the authenticatee being used as an encryption key;
storing the trust information as a trust information database record in a storage device;
receiving a specific identification tag of the terminal belonging to the authenticatee from a server;
decrypting the record of the trust information database by a calculation part, the specific identification tag of the terminal belonging to the authenticatee being used as a decryption key; and
performing an identification judgment of the terminal belonging to the authenticatee based on the additional information.

22. The method according to claim 19, wherein the trust information further includes flag information which expresses whether the terminal belonging to the authenticatee is authenticated by the trust information provider or not.
